(19) United States
(12) Patent Application Publication
(10) Pub. No.: US 2023/0417087 A1
(43) Pub. Date: Dec. 28, 2023

(54) Module for Generating Opening Signals

(71) Applicant: Illinois Tool Works Inc., Glenview, IL (US)

(72) Inventors: Joachim OBERST, Großrinderfeld (DE); Zsolt WILKE, Bad Mergentheim (DE); Erik DILJE, Würzburg (DE); Andreas RUDOLF, Eibelstadt (DE)

(21) Appl. No.: 18/213,455

(22) Filed: Jun. 23, 2023

(30) Foreign Application Priority Data
Jun. 24, 2022 (DE) 10 2022 115 843.8

(51) Int. Cl. E05B 81/76; E05B 81/50

(52) U.S. Cl. CPC E05B 81/76; E05B 81/50

(57) ABSTRACT

The present disclosure relates to a module (100) for generating signals, in particular signals for opening vehicle doors or flaps. The module (100) includes: a housing (102) having a switch region (104); a switch (108), in particular a microswitch, which is connected, in particular releasably connected, to the switch region of the housing (102); and an actuating flap (120), which is pivotally connected to the housing (102). The actuating flap (120) is configured to be pivoted by a movement of an operating element, such as a door lever, between a first position and a second position in which the switch (108) is activated by the actuating flap (120).

### RELATED APPLICATION

The present application claims the benefit of German Patent Application No. 10 2022 115 843.8, filed Jun. 24, 2022, the contents of which are hereby incorporated by reference.

### BACKGROUND

Signal generators are required to control drives, in particular electrical drives, that enable the automatic opening of a vehicle door. The signal generators are configured as microswitches, for example, and are typically actuated by the user. For this purpose, the switches for signal generation can be connected to various actuating mechanisms, such as knobs or levers. To open the vehicle door, the actuating mechanism, for example a door lever, is moved to an open position by the user, thereby closing the switch and therefore an electrical drive circuit.

For example, the vehicle doors can consist of a sliding door or a swing door. In particular, due to the narrow interior of such vehicle doors, it is often very complex and challenging to achieve a reliable connection between the contacts of the switch and the electrical drive. Also, premature wear of the switch can occur very quickly.

Based on the aforementioned problem, the object of the disclosure is to simplify the installation of signal generators or to improve hold times.

### SUMMARY

The disclosure relates to a module for generating signals, in particular signals for opening vehicle doors or flaps, substantially as illustrated by and described in connection with at least one of the figures, as set forth more completely in the claims. According to a further aspect, the disclosure relates to an actuating mechanism and a vehicle having the module according to the disclosure. The disclosure will be described in further detail below with respect to the examples shown in the figures.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a schematic perspective view of a module according to an example of the present disclosure.

FIG. 2 is a schematic bottom perspective view of the module shown in FIG. 1.

FIG. 3 is a schematic cross-section through the example of the module shown in FIG. 1.

FIG. 4 is a schematic side perspective view of the module according to FIG. 1 in a first position of the actuating flap.

FIG. 5 is a schematic side perspective view according to FIG. 4 in a second position of the actuating flap.

FIG. 6 is an exploded view of the components received in the housing.

FIG. 7 is a schematic top perspective view of an example of the module according to the present disclosure.

FIG. 8 is a schematic side perspective view of the module according to FIG. 7 in a first position of the actuating flap.

FIG. 9 is a schematic cross-section through the module shown in FIG. 8.

FIG. 10 is a schematic side perspective view of the module according to FIG. 7 in a second position of the actuating flap.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Accordingly, the present disclosure relates to a module for generating signals, in particular to signals for opening vehicle doors, the module comprising: a housing having a switch region; a switch, in particular a microswitch, which is connected, in particular releasably connected, to the switch region of the housing; an actuating flap, which is pivotally connected to the housing and configured so as to be pivoted by a movement of an operating element, in particular a door lever, between a first position and a second position in which the switch is activated by the actuating flap.

The pivotable actuating flap, which is arranged between the operating element configured as a door lever and the switch, can be used in order to transfer force to the switch without exerting significant shearing forces on the switch. This significantly reduces the wear on the switch. Also, by providing the actuating flap, the lift of the operating element (e.g., the door lever) can be reduced. The operating element can thus activate the actuating flap already when it is pivoted by 5° or less.

According to a further example, the switch comprises an actuating element, in particular a latchkey, extending in a first direction, wherein the actuating flap is pivotable opposite a pivot axis, and wherein the pivot axis extends substantially perpendicular to the first direction. Thus, the actuating forces exerted by the actuating flap on the actuating element are introduced substantially perpendicularly into the actuating element. This simplifies the activation of the actuating element and further reduces wear.

According to a further example, the actuating flap comprises a curved cover region, which is configured so as to at least partially cover an actuating element, in particular a latchkey, of the switch. By means of such a curved region, the actuating flap not only serves to operate the actuating element of the switch, but also protects it. The operating element is then protected against debris, for example dust or water ingress, in both positions of the actuating flap.

According to a further example, the module comprises a first resetting element, which biases the actuating flap into the first position. In its resting position, the actuating flap does not actuate the switch. As a result, the electrical signal generated by the switch for the door opener is directly interrupted as soon as the door lever is no longer pulled by the user.

According to a further example, the first resetting element is configured so as to generate a haptic and/or audible signal when the actuating flap is transferred into its second position. The resetting element thus has a dual function. On the one hand, it serves to bias the actuating flap into its first position. On the other hand, the first resetting element can thus serve to provide feedback to the user as soon as the switch has been activated. For example, the first resetting element can be configured as a flat spring, in particular as a snap frog. This flat spring can be attached to the housing such that, as soon as the actuating flap has reached its second position, the flat spring snaps over. This snapping results in a sudden change in the resetting force, which the user can recognize as haptic feedback. At the same time, the snapping can be accompanied by a clicking sound, which provides acoustic feedback to the user.

According to a further example, the module comprises a second resetting element, in particular a resetting spring, which is configured so as to act against further movement of the operating element after the actuating flap has been transferred into its second position. In other words, the second resetting element of the module can act as a stop for the movement of the operating element. The second resetting element configured as a resetting spring generates a resistance on the one hand against the further movement of the operating element after activation of the microswitch. On the other hand, it allows for a movement beyond the opening position of the operating element for activating the microswitch. This can, for example, serve to achieve an emergency release position of the operating element if the electrical drive fails. The second resetting element achieves resistance against further movement of the operating element after the microswitch has been activated. This resistance is initially perceived as a stop for the operating element by the user. However, when the user tries to move the operating element more strongly against the resistance, the second resetting element is deformed, accordingly permitting the operating element to move into the emergency release position. For example, the operating element can be designed as a door lever, in which a Bowden cable is activated by a further pull on the lever after achieving the open position, which is coupled to a mechanical emergency release.

According to a further example, the actuating flap comprises a protrusion, which projects over a surface of the actuating flap facing away from the switch and is configured so as to transfer a substantially translational movement of an operating element, in particular a door lever, into a pivoting movement of the actuating flap. As will be explained in further detail below, the protrusion can thereby move off of a ramp provided on the operating element, whereby the actuating flap is pushed towards the switch. According to a further example, the protrusion comprises a ramp region and a shoulder region, wherein the ramp region preferably has a slope of 10° to 45°.

According to yet another aspect, the present disclosure relates to an actuating mechanism for opening vehicle doors, wherein the actuating mechanism comprises the following: a door lever housing having a door lever stored therein in a movable, and preferably pivotable, manner; and a module described above, wherein the module is releasably connected to the door level housing such that the actuating flap is arranged between the door lever and the switch.

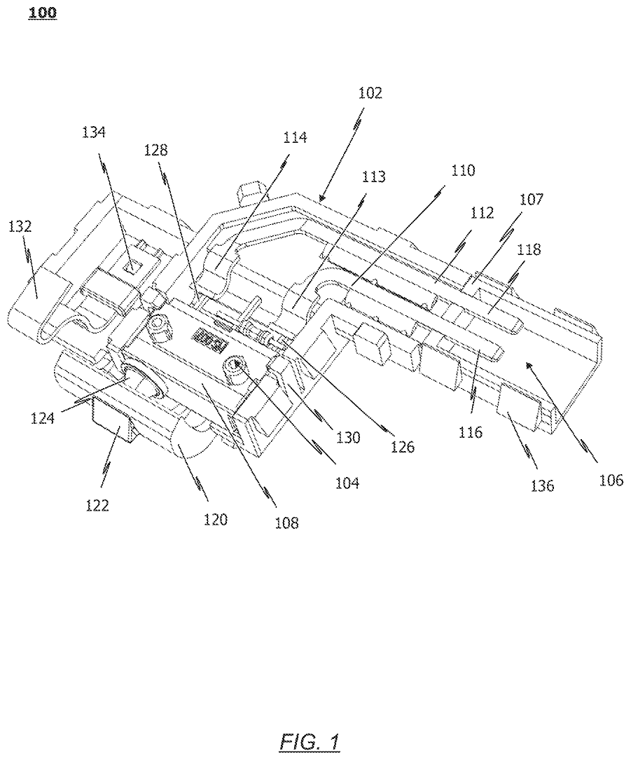

FIG. 1 shows a first example of a module for generating opening signals in accordance with the present disclosure. The module 100 comprises a housing 102 having a switch region 104 and a plug-in region 106. The housing 102 shown herein is formed in one piece. This can be configured as a plastic body manufactured in an injection molding process, for example.

The housing 102 is configured as an upwardly open half-shell. The half-shell can be releasably connected to an operating element housing in particular, for example a door lever housing (not shown). For this purpose, the housing 102 can comprise a plurality of ramp-like projections 136, which serve to releasably connect the module 100 to the operating element housing, in particular to clip it to said housing. It should be noted that the housing 102 of the module alternatively also connects to many other movable vehicle components, such as glove compartments, rear flaps, center arm rests, etc., to generate an electrical signal upon actuation of the vehicle components.

A switch, in particular a microswitch 108, is releasably connected to the switch region 104 of the housing 102. For this purpose, the housing 102 can comprise one or more receiving openings, which serve to align the switch with respect to the housing 102. FIG. 1 further includes snap-fit connectors 130 configured as snap hooks that releasably connect the switch 108 to the housing. As will be described in more detail below, the switch 108 is in particular configured as a button; however, any further mechanical or electrical switch variant is also conceivable.

The module 100 has first and second electrical contacts 110, 112. The electrical contacts 110, 112 each have a first end 113, 114 and an opposing second end 116, 118. At the first ends 113, 114, the electrical contacts are connected to corresponding contacts of the switch 104. More particularly, the first electrical contact 110 is connected at its first end 113 to a first contact 126 of the switch 108. The second electrical contact 112 is connected to a second electrical contact 128 of the switch 108 via its first end 114.

The second ends 116, 118 of the electrical contacts 110, 112 extend into a plug-in region 106 of the housing 102. The plug-in region 106 serves in particular to receive a corresponding plug for supplying voltage to an electric drive, or to supply every other consumer. For example, such a plug can be inserted into the plug-in region 106 and pushed onto the second ends 116, 118 of the electrical contacts 110, 112. For this purpose, the shape of the second ends 116, 118 is adapted to the respective plugs. In other words, the electrical contacts 110, 112 serve as adapters between the terminals of the switch 108 and the plug. The module can thus be easily adapted to different plugs, for example by attaching electrical contacts 110, 112 with alternatively shaped second ends (not shown). Thus, replacing the switch 108 is not necessary.

For example, the second ends 116, 118 of the electrical contacts 110, 112 can be received in a rear wall 107 of the plug-in region 106. In the illustrated example, the rear wall 107 is in particular configured with two recesses, wherein each of the recesses serves as a guide for one of the two electrical contacts 110, 112.

The electrical contacts 110, 112 extend substantially perpendicularly, that is, at an angle of about 90°, between the first and second ends 113, 114, 116, 118.

In the example according to FIG. 1, the plug-in region 106 is formed as a half-shell. The first (e.g., “lower”) half-shell shown here can be completed by a corresponding second (e.g., “upper”) half-shell that is part of the operating element housing. The two half shells form a complete socket for receiving a corresponding plug of the electric drive. Accordingly, once the second half-shell of the operating element housing is connected to the first half-shell, the electrical contacts are fixedly connected to the rear wall 107 of the plug-in region 106.

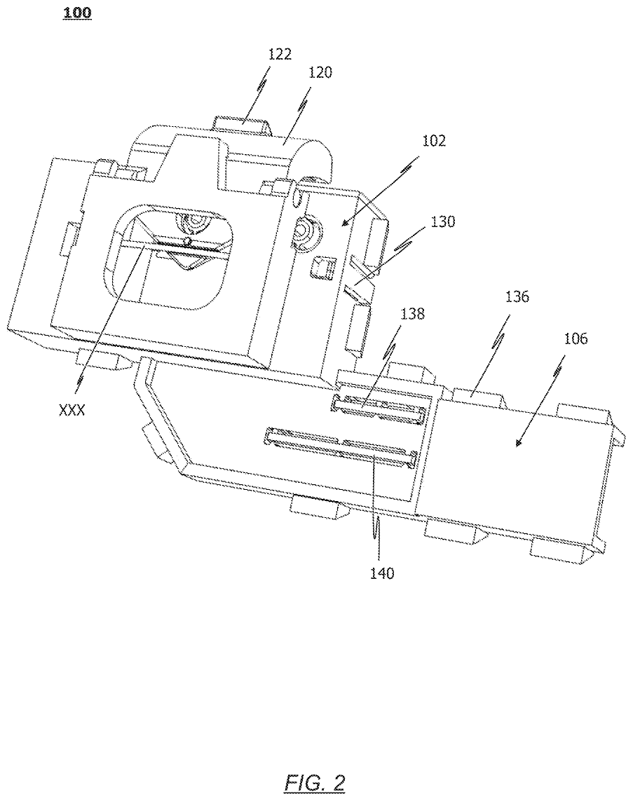

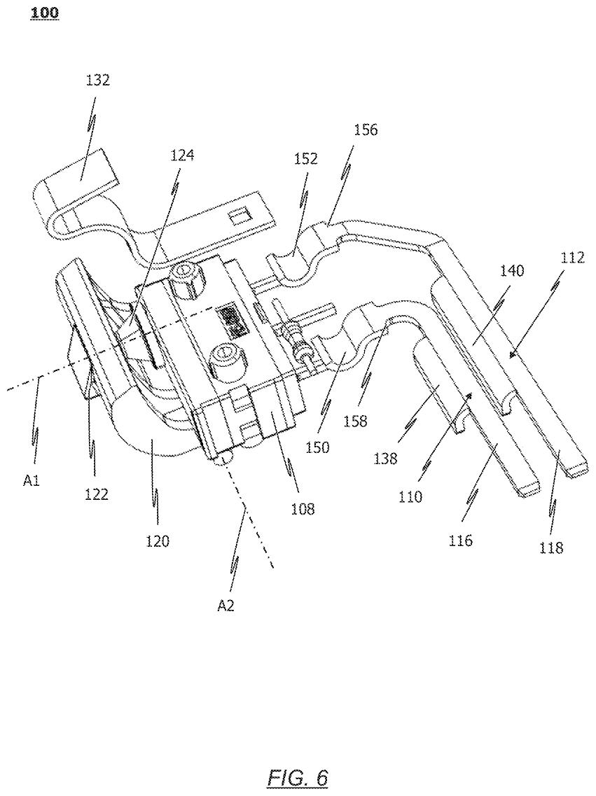

It can further be seen from FIGS. 2 and 6 that the two electrical contacts 110, 112 are each equipped with anchoring elements 138, 140. The anchoring elements 138, 140 serve to releasably connect the electrical contacts to the housing 102. To this end, the anchoring members 138, 140 are inserted into corresponding openings of the housing 102.

The first ends 113, 114 of the electrical contacts 110, 112 are designed elastically. The first ends can in particular also be designed to be biased against the first and second contacts 126, 128 of the switch 108 upon insertion of the anchoring elements 138, 140 into the housing 112. In other words, elastic deformation of the first ends 113, 114 preferably occurs once the anchoring elements are inserted into the housing 102. This is the case because the first ends 113, 114 and the contacts 126, 128 of the switch are arranged to overlap each other when the electrical contacts are inserted into the housing.

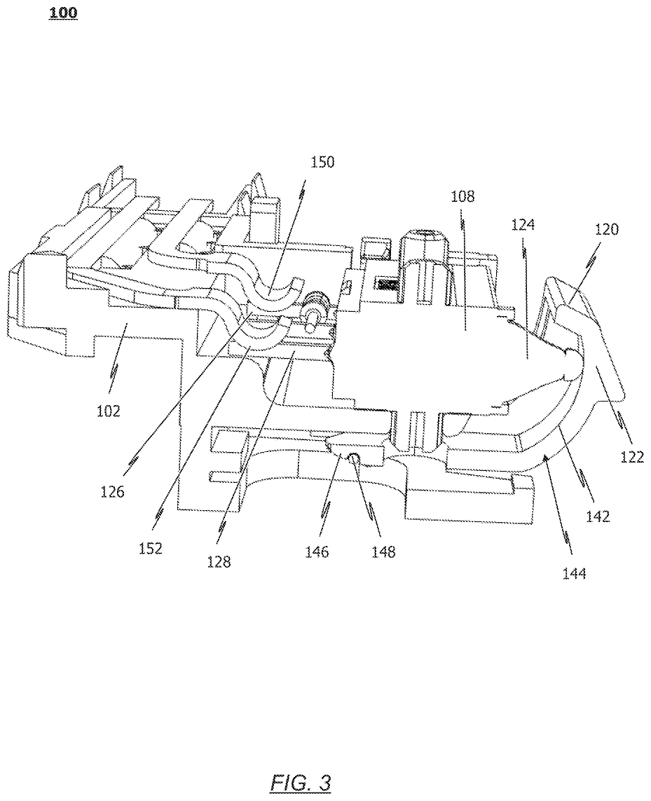

The first ends 113, 114 of the electrical contacts 110, 112 have white arc-shaped, in particular U-shaped, regions 150, 152, as can be seen for example in FIG. 3. The arc-shaped regions 150, 152 of the electrical contacts 110, 112 are configured to protrude when installed relative to the remaining portions of the contacts. In other words, the arc-shaped regions 150, 152 are arranged outside the plane of the remaining regions of electrical contacts. Accordingly, it can be ensured that only the bent regions 150, 152 are pressed and deformed against the electrical contacts 128, 126 of the switch 108 when the electrical contacts are inserted into the housing 102. The electrical contacts 110, 112 can also be additionally pressed onto the electrical contacts 126, 128 of the switch 108 by the operating element housing when connected to the housing 102.

The arc-shaped regions 150, 152 are designed to establish a linear contact between the electrical contacts 110, 112 and the terminals (contacts) of the switch 108. In the cross-sectional view shown in FIG. 3, the contact is made between the lower end of the U-shaped regions 150, 152 and an upper surface of the contacts 126, 128. The linear contact therefore extends into the drawing plane of FIG. 3. Instead of the arc-shaped regions 150, 152, other shapes that allow for linear contact with the terminals/contacts 126, 128 of the switch 108 can also be chosen. For example, the first ends could also be provided with a V-shaped region.

As shown in FIG. 6, the first ends of the electrical contacts 110, 112 have a flaring 156, 158. The flarings 156, 158, in particular, serve to provide a larger abutment surface area of the first end opposite the contacts 126, 128 of the switch 108.

The switch 108 is a button configured as a micro-switch, which comprises a push button 124 for activating the switch. For example, the push button 124 can be biased into the position shown in FIG. 1. To this end, a resetting element (not shown), for example a flat spring, is provided within the microswitch 108. In conventional signal generators for opening signals of electrical door drives, corresponding buttons are controlled directly via an actuating mechanism. The actuating mechanism can be, for example, a door lever or a door knob. In contrast, the module 100 according to the present disclosure comprises an actuating flap 120. In the installed state of the module 100, this is arranged between the actuating mechanism and the push button 124 of the microswitch 108. The actuating flap serves to protect the push button 124 from wear and tear. In particular, the actuating flap 120 reduces a shear movement relative to the push button 124 to a minimum.

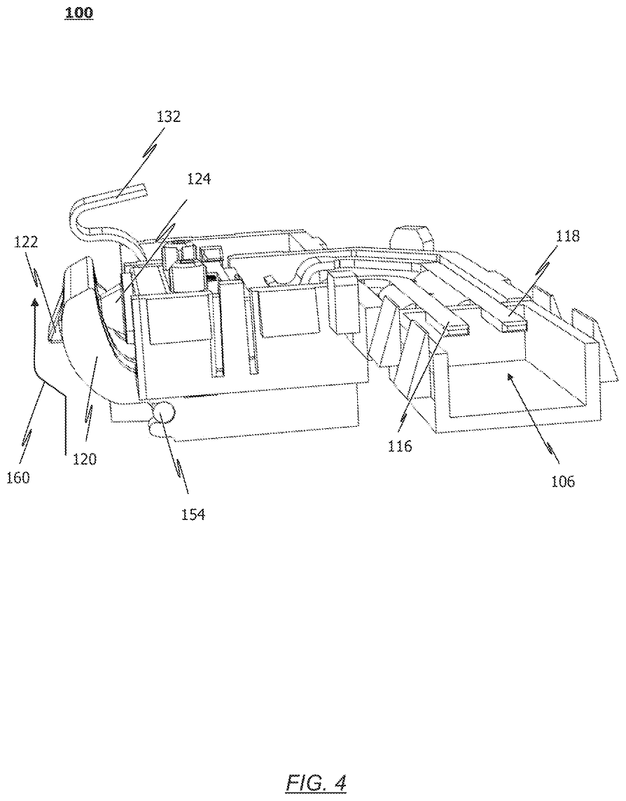

The actuating flap 120 is hinged to the module housing 102 in a manner enabling it to pivot. For this purpose, the actuating flap 120 comprises one or more pivot pins (154, FIG. 4), which are anchored in corresponding pivot sockets of the housing 102. The actuating flap 120 is pivotable relative to the pivot axis A2 shown in FIG. 6. The pivot axis A2 is oriented substantially perpendicularly to a longitudinal axis A1 of the push-button 124.

As can be seen in particular in FIG. 3, the actuating flap 120 comprises a curved inner surface 124, which is preferably in contact with the push button 124. Thus, when the actuating flap 120 is pivoted, the push button 124 can be actuated.

To pivot the actuating flap 120, it has a protrusion 122. For example, from FIG. 3, it can be seen that this protrusion 122 has a ramp-shaped region and a shoulder region. The protrusion 122 serves to translate a substantial movement of the actuating mechanism (e.g., door lever) into a pivoting movement of the actuating flap 120 opposite the microswitch 108.

A first resetting element shown as a wire spring 148 is further discernible in FIG. 3. The wire spring 148 is connected to the housing 102 on the one hand and to a lever region 146 of the actuating flap 120 on the other hand. The first resetting element which is configured as the wire spring 148 serves to bias the actuating flap 120 into the first position shown in FIG. 3. In the first position shown in FIG. 3, the actuating flap 120 is in particular arranged such that the push button 124 abuts the curved inner surface 142. A pivoting of the actuating flap 120 towards the push button 124 is accomplished against the return force of the wire spring 148.

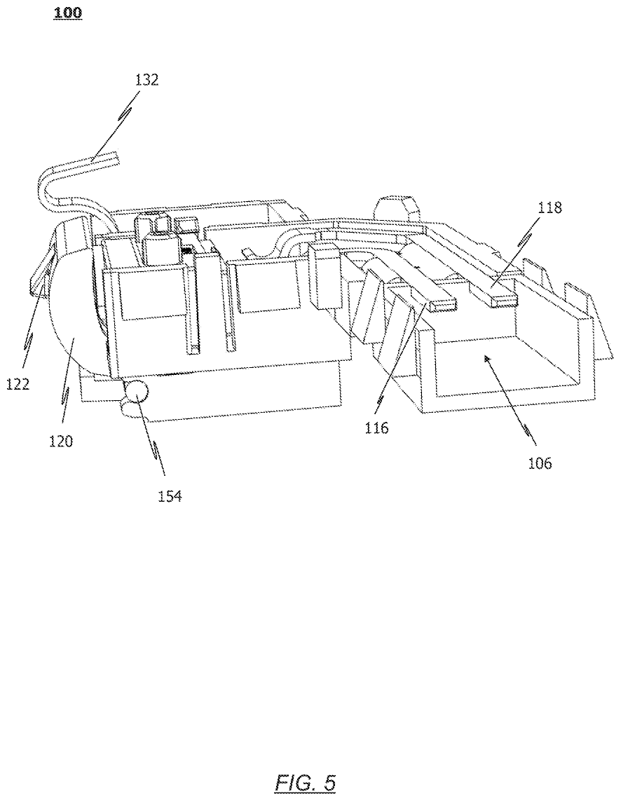

FIGS. 4 and 5 show a comparison of the module in a first and a second position of the actuating flap 120. In the normal state, that is, when the switch 108 is not to be actuated, the actuating flap 120 is in the first position shown in FIG. 4. In this first position, for example, the actuating flap abuts the tip of the push button 124. However, in this position, activation of the switch 108 by the push button 124 does not yet occur.

A surface 160 of an actuating mechanism is schematically shown in FIG. 4. The ramp-like surface 160 is herein oriented opposite the module and therefore opposite the actuating flap 120, such that when the actuating mechanism (for example, pivoting the door lever) moves over the protrusion 122, it thus pivots the actuating flap 120 towards the push button 124.

A second position of the actuating flap 120 is shown in FIG. 5. In FIG. 5, the actuating flap 120 was pivoted clockwise by contacting the ramp-like surface 160 with the protrusion 122, that is, towards the push button 124. This activates the microswitch 108 without imparting significant longitudinal forces on the push button 124. Rather, the interaction of the ramp-shaped surface 160 with the protrusion 122 translates the substantially translational movement of the actuating mechanism into a pivoting movement of the actuating flap 120, which then acts on the switch in the longitudinal direction of the push button 124. Thus, wear of the push button 124 is significantly reduced.

The module 100 further includes a second resetting element 132, shown herein as a return spring. The second resetting element 132 is arranged adjacently to the actuating flap 120, as shown in FIGS. 4 and 5. The second resetting element 132 is arranged such that the ramp-shaped surface 160 first contacts the protrusion 122 and transfers the actuating flap 120 into its second position before the actuating mechanism (e.g., the door lever) contacts the second resetting element 132. By contacting the actuation mechanism with the second resetting element 132, there is further haptic feedback for the user. In particular, the second resetting element 132 acts as a movable stop. This means that, upon contact of the actuating mechanism with the second resetting element 132, the user initially experiences a resistance that acts against further movement of the actuating mechanism and feels like a limit stop during normal actuation. However, the second resetting element 132 can still be moved against its resetting force, especially when the actuating mechanism is continued with higher force. This can be used, for example, to further move the actuation mechanism for a mechanical emergency release (e.g., via a Bowden cable) than is the case due to the perceived end stop. Of course, this is only necessary in exceptional cases, so that the resetting force of the second resetting element 132 can be set relatively high.

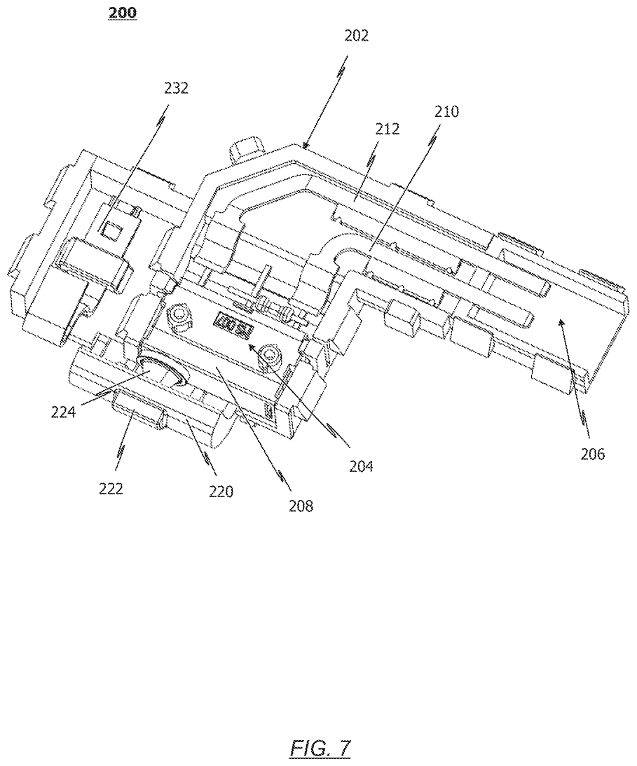

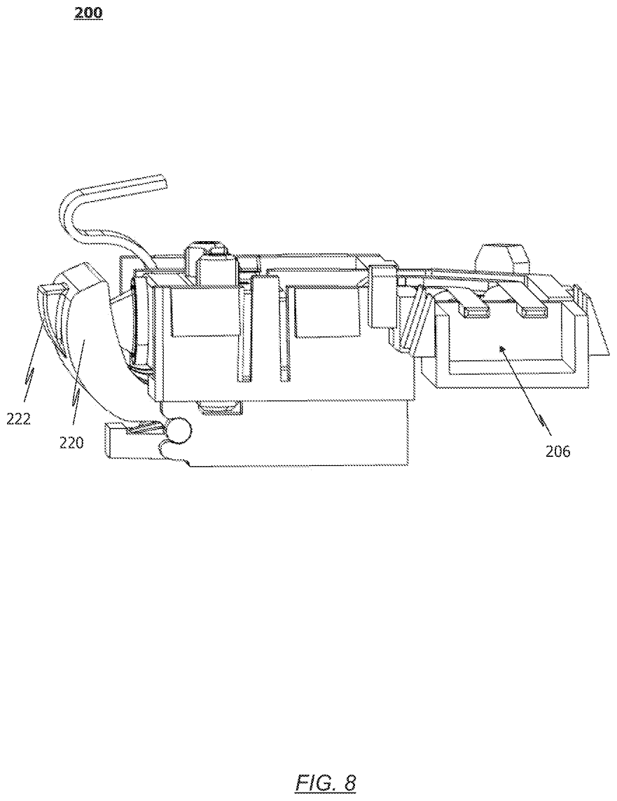

A second example of a module 200 according to the present disclosure can be seen in FIGS. 7-10. Herein FIG. 7 shows a schematic top perspective view of the module 200 according to the second example. The module 200 according to the second example also comprises a preferably one-piece housing 202. The housing 202 has a switch region 204 that is connected to a plug-in region 206. A switch, in particular a microswitch 208, is releasably connected to the switch region 204 of the housing 202. First and second electrical contacts 210, 212 are connected to the contacts of the switch 208 and at least partially extend into the plug-in region 206 of the housing 202. An actuating flap 220 is pivotally arranged on the housing 202. The actuating flap 220 serves to actuate a push button 224 of the switch 208. A second resetting element 232 is arranged adjacently to the actuating flap 220 and acts as a stop for the actuating mechanism in its open position.

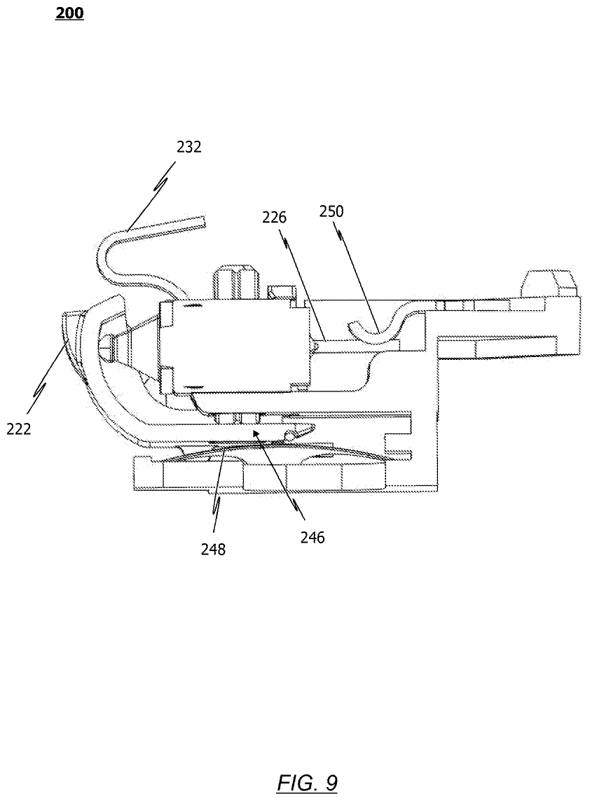

The switch 208, electrical contacts 210, 212, and second resetting element 232 are substantially identical to the corresponding elements of the first module 100. The module 200 differs from the module 100 in particular by the configuration of the actuating flap 220 and the first resetting element 248 shown in FIG. 9.

Compared to the actuating flap 120 of the module 100, the actuating flap 220 of the module 200 has a protrusion 222 which is arranged inversely. In other words, the protrusion 222 has a protrusion with a shoulder region that is oriented upward. In contrast, the ramp region is oriented downward.

It can be seen from FIG. 9 that the actuating flap 220 is biased into the first position. In particular, it is biased into the first position by a first resetting element. The first resetting element 248 is configured as a flat spring connected to the housing 202 of the module 200. The flat spring is arranged at the bottom, i.e., a lever portion 246 of the actuating flap 220, in the illustration according to FIG. 9. The flat spring 248 pushes the actuating flap 220 counterclockwise in FIG. 9 and thereby biases it into the first position. As long as the actuating mechanism is not activated, the actuating flap 220 is biased into the first position shown in FIG. 9.

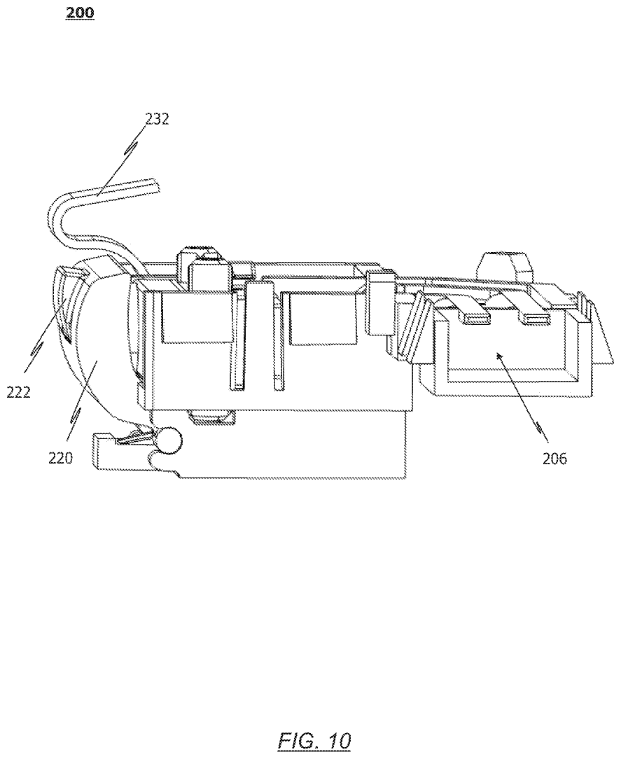

FIG. 10 shows module 200 in the second position. The flat spring 248 is deformed in the second position (not shown). When the actuating flap 220 is transferred into the second position, the flat spring, which is in particular configured as a snap frog, is snapped over. This generates an acoustic signal/feedback signaling to the user that actuation of the actuating flap and thus the switch 208 has occurred.

For example, when the switch 208 is actuated, a circuit can be closed to provide a power supply to a consumer, for example an electric drive for opening/unlocking doors. In other examples, the circuit can be closed in the idle state of the switch, thereby interrupting the circuit upon actuation of the switch by the control element and the actuating flap 220. The disclosure is thus not limited to the function of the switch shown herein, but essentially relates to actuation of the switch by the actuating flap 220, which is arranged between the control element (e.g., door lever) and the switch 108.

Another aspect lies in the connection of the terminals of the switch 108 to the plug-in region 106 by the electrical contacts 110, 112.

Once the user releases the actuation mechanism, the actuating flap 220 is transferred into the first position by the flat spring 248. The flat spring 248 shown in FIG. 9 not only serves to bias the actuating flap 220 to its first position, but also allows for further acoustic and/or haptic feedback upon activation of the switch 208.

Alternatively, the actuating flap 220 can also be biased against the switch in its rest position, i.e., the actuating flap 220 can hold the switch pressed in its rest position. Accordingly, moving the actuating flap, in particular by pivoting, through the control element (e.g., door lever), would lead to the release or opening of the switch.

The present disclosure is not limited to the examples shown in the figures, but rather, results when all of the features disclosed herein are considered together. In particular, it is conceivable, for example, to apply the wire spring of the first example in the second example. The same applies to the flat spring according to the second example, which can also be applied to the first example. The orientation of the protrusion of the actuating flap is also freely selectable. Also, only one switch is shown in each of the figures. However, it is conceivable that two or more switches are accommodated in the housing, and the electrical contacts are in communication with all the switches simultaneously.

What is claimed is:

1. A module (100) for generating signals for opening vehicle doors or flaps, the module (100) comprising:
a housing (102) having a switch region (104);
a switch (108) connected releasably to the switch region of the housing (102); and
an actuating flap (120), which is pivotally connected to the housing (102) and configured so as to be pivoted by a movement of an operating element between a first position and a second position in which the switch (108) is activated by the actuating flap (120).

2. The module (100) according to claim 1, wherein the switch (108) comprises an actuating element (124) extending in a first direction, and wherein the actuating flap (120) is pivotable about a pivot axis, wherein the pivot axis extends substantially perpendicular to the first direction.

3. The module (100) according to claim 1, wherein the actuating flap (120) comprises a curved cover region, which is configured so as to at least partially cover an actuating element of the switch (108).

4. The module (100) according to claim 1, wherein the module (100) comprises a first resetting element (148, 248), which biases the actuating flap (120) into the first position.

5. The module (100) according to claim 4, wherein the first resetting element (248) is configured so as to generate a haptic and/or audible signal when the actuating flap (120) is transferred into its second position.

6. The module (100) according to claim 1, wherein the module (100) comprises a second resetting element (132), which is configured so as to act against further movement of the operating element after the actuating flap (120) has been transferred into its second position.

7. The module (100) according to claim 1, wherein the actuating flap (120) comprises a protrusion (122), which projects over a surface of the actuating flap (120) facing away from the switch (108) and is configured so as to transfer a substantially translational movement of an operating element into a pivoting movement of the actuating flap (120).

8. The module (100) according to claim 7, wherein the protrusion (122) comprises a ramp region and a shoulder region, wherein the ramp region preferably has a slope of 100 to 45°.

9. The module (100) according to claim 2, wherein the actuating element (124) is a spring.

10. An actuating mechanism for opening vehicle doors, wherein the actuating mechanism comprises the following:
an operating element housing having an operating element stored therein in a pivotable, manner; and
a module (100) according to claim 1,
wherein the module (100) is connected to the operating element housing such that the actuating flap (120) is arranged between the operating element and the switch (108).

11. The actuating mechanism according to claim 10, wherein the operating element is a door lever.

12. A vehicle having the actuating mechanism according to claim 10.

13. The module (100) according to claim 6, wherein the second resetting element (132) is a resetting spring.
